(19) United States
(12) Patent Application Publication
(10) Pub. No.: US 2006/0051558 A1
(43) Pub. Date: Mar. 9, 2006

(54) Multilayer film with adjustable water vapor permeability

(76) Inventors: Marco Sieber, Horw (CH); Reto Sieber, Sigigen (CH)

Correspondence Address: JORDAN AND HAMBURG LLP, 122 EAST 42ND STREET, SUITE 4000, NEW YORK, NY, 10168, US

(21) Appl. No.: 11/221,280

(22) Filed: Sep. 6, 2005

(30) Foreign Application Priority Data
Sep. 6, 2004 (DE) 10 2004 043 010.1
Aug. 17, 2005 (DE) 10 2005 038 863.9

(51) Int. Cl. B32B 3/10

(52) U.S. Cl. 428/131

(57) ABSTRACT

The invention relates to a water-tight and water vapor permeable multilayer film, in particular for sealing in the roof area during home construction, with a water vapor permeable base layer made of a first plastic material and with at least one water vapor permeability-controlling second layer that is coupled to the base layer and that is made of a second plastic material. The base layer is water-tight for low surface tension water and the multilayer film is extensible and tear-resistant. The water vapor permeability-controlling second layer is inventively provided with macroscopic holes, the arrangement of which removes a defined surface area from the second plastic material so that the water vapor permeability of the multilayer film is adjusted. The invention also relates to the use of such a multilayer film as adhesive tape and/or vapor barrier and/or facade film and/or on-roof film, in particular for sealing in the roof area during home construction. The invention furthermore relates to a system that comprises the multilayer film described in the foregoing and an adhesive tape that comprises the multilayer film.

### BACKGROUND OF THE INVENTION

The invention relates to a multilayer film that is water-tight and water vapor permeable for use in home or other building construction, for instance for sealing in particular in the roof area during home construction, with a water vapor permeable base layer made of a first plastic material and with at least one water vapor permeability-controlling second layer that is coupled to the base layer and that is made of a second plastic material, the use of such a multilayer film as an adhesive tape and/or vapor barrier and/or facade film and/or on-roof film, as well as to a system made of such a multilayer film and a multilayer film designed as an adhesive tape and to a method for producing such a multilayer film.

In general because of increasing environmentally focused methods used in home construction and home renovation, it is becoming increasingly important to seal the roof area, in particular beneath the roof and/or on the roof and/or the facade area so that it is water-tight and water vapor permeable in order to create a pleasant and healthy living climate while still preventing rain water from penetrating. While laying and gluing film for this it is therefore very important that no open areas occur in the seal due to warping in the films in the area of joints between the strips of film. Furthermore, care must be taken that the water vapor permeability of the materials used is high enough that condensation does not occur under these films. The problems cited above occur in particular with conventional seals in which films/adhesive tapes are used that cannot flexibly compensate warping and joint openings up to a certain degree and that have incorrect water vapor permeability (water vapor permeability that is too low or too high). Furthermore, with all of the aforesaid requirements it must be assured that the materials used have adequate strength and mechanical stability, particularly in home construction. In addition, a film/adhesive tape should be as simple and cost-effective to produce as possible with reproducible product properties.

Normally films made of plastic material, e.g. appropriate polymer films, are blown or cast as monolayer or multilayer films. Typical methods are described in the literature, for instance by K. R. Osborn and W. A. Jenkins, Plastic Films: Technology and Packaging Applications, Technomic Publishing Co., Inc., Lancaster, Pa. 1992. Although properties of such films such as tensile strength and extensibility are varied in wide ranges for instance by appropriate selection of film thickness or polymer used, water vapor permeability cannot be appropriately adjusted as desired and is too low for certain uses, as described in the foregoing and e.g. also when such films are used for food packagings. In addition, strength and mechanical stability are not provided in all circumstances. Furthermore, known film materials are expensive and complex to produce. It is difficult to reproducibly adjust the product properties of such films.

U.S. Pat. No. 6,540,949 describes a method for producing bi-oriented polyethylene films with high water vapor permeability. In it, a water vapor permeable base film made of a first plastic material is coated with one or a plurality of very thin water vapor permeability-controlling film layers that are no more than approx. 0.0038 mm thick. The degree of water vapor permeability is thus determined using the water vapor permeability of the base layer and the thickness of the water vapor permeability-controlling film layer or layers. Since the thickness of the water vapor permeability-controlling film layer or layers is very low, however, this thickness and thus the resulting water vapor permeability of the embodied multilayer film cannot be precisely controlled. In addition, since the base film has a microporous structure due to the addition of fillers and the thickness of the additional water vapor permeability-controlling film layer or layers is very thin, the multilayer films produced in this manner do not in all circumstances have satisfactory tensile strength, mechanical stability, and extensibility. However, if the film layers described in the cited US patent are made thicker, the water vapor permeability then decreases so that it is about the same as that of conventional films if the base film has a thickness of approximately 0.05 mm.

Known from Offenlegungsschrift DE 101 16 477 A1 is a roof lining web that is water-tight and open to vapor diffusion and that is made of a complex composite that has at least three layers and that is based on thermoplastics with a vapor-permeable interior layer made of a porous substrate, a vapor-permeable but liquid-impermeable middle layer made of porous film, and a vapor-permeable but liquid-impermeable embossed and perforated film that has a three-dimensionally structured surface. An additional interlaid scrim layer arranged on the interior side of the roof is provided in order to assure mechanical sturdiness. The roof lining web is not extensible.

Offenlegungsschrift DE 198 19 085 A1 describes a water-tight and water vapor permeable flat material made of a microporous film and a water-tight membrane that uses relatively expensive materials and whose product properties must be adjusted via the layer thicknesses used for the film and/or the membrane. An additional reinforcing layer is provided for ensuring high stability.

Utility model DE 297 00 987 describes a diffusion-permeable under-roof membrane made of a composite with at least three layers and with exterior non-woven layers and an interior microporous film layer without holes.

In general multilayer films based on microporous films have the disadvantage that they are not water-tight for low surface tension water. Such low surface tension water, that is, water with a reduced surface tension, can occur for instance when pollutants in the roof region mix with rain water. Low surface tension water does not form drops or tends not to form drops. Low surface tension water in the sense of the foregoing and in the sense of the following specification and the claims shall be defined as water with a surface tension of 0.04 N/m to 0.045 N/m, for instance soapy water produced by the addition of rinse agents or washing agents, such as surfactants, to distilled water.

It is the object of the present invention to provide a multilayer film that is water-tight and water vapor permeable, in particular for sealing in the roof area during home construction, that overcomes the disadvantages of the films in the prior art, in particular to provide a multilayer film that offers very good mechanical stability and that can be produced simply, cost effectively, and with reproducible product properties, whereby the water vapor permeability is adjustable. In addition, a corresponding production method for such a multilayer film should be provided.

Furthermore, the inventive multilayer film should have particularly high water vapor permeability and high resistivity to mechanical loads, such as tensile loads, and high extensibility.

### SUMMARY OF THE INVENTION

The inventive multilayer film is designed water-tight and water vapor permeable and has high mechanical stability. It is in particular for sealing in the roof area during home construction. The inventive multilayer film has a water vapor permeable, water-tight base layer made of a first plastic material and at least one water vapor permeability-controlling second layer that is coupled to the base layer and that is made of a second plastic material. In accordance with the invention, the base layer is water-tight for low surface tension water. Furthermore, the multilayer film is inventively extensible and tear-resistant. The water vapor permeability-controlling second layer is provided with macroscopic holes, the arrangement of which removes a defined surface area from the second plastic material so that the water vapor permeability of the multilayer film is adjusted. The more plastic material removed, the greater the water vapor permeability. The inventive combination of the base layer that is water-tight for low surface tension water and the at least one water vapor permeability-controlling second layer, whereby the multilayer film can be extensible and can have a certain tear resistance, and whereby this second layer is provided with macroscopic holes, the arrangement of which removes a defined surface area from the material of the second layer, makes it possible to provide in a particularly cost-effective manner a mechanically loadable and stable multilayer film that is water-tight and water vapor permeable and in which the water vapor permeability can be adjusted in a simple manner. In particular providing holes is substantially easier and more reproducible than for instance adjusting the thickness of a very thin additional coating, whereby the number, size, and position of the inventively provided holes in the second layer, comprising the second plastic material, makes it particularly easy to adjust the appropriate water vapor permeability. In particular the mechanical load carrying ability can be adjusted as desired using the different thickness selected for the second layer, depending on the use for the multilayer film, without this affecting the water vapor permeability.

In accordance with one preferred embodiment, the inventive tear-resistant multilayer film has a tear-resistance in accordance with DIN 53504 of greater than 3 N/mm², preferably greater than 5 N/mm², more preferably greater than 7 N/mm², particularly preferably greater than 9 N/mm², very particularly preferably greater than 11 N/mm² or greater than 13 N/mm², or most particularly preferably greater than 15 N/mm².

The macroscopic holes can preferably be round, oval, square, rectangular, rhomboidal, or of a different shape, whereby the arrangement can be provided very dense, in rows and columns, or distributed evenly across the surface area and/or arranged randomly.

The diameter of the macroscopic holes is preferably in a range from 0.1 mm to 100 mm, preferably from 0.2 mm to 50 mm, more preferably from 0.4 mm to 20 mm, particularly preferably from 0.5 mm to 8 mm, and most preferably from 0.6 mm to 6 mm. This is the diameter in the case of round macroscopic holes or the largest diameter in the case of oval macroscopic holes or it is the edge length in the case of polygonal macroscopic holes.

The water vapor permeability of the first plastic material is preferably greater than the water vapor permeability of the second plastic material. This means the water vapor permeability of the multilayer film can be adjusted in a particularly simple manner since it is thus particularly simple to change the number, size, and position of the inventively provided holes in the second layer, comprising the second plastic material, and thus, in combination with the greater water vapor permeability of the first plastic material, rendering the overall water vapor permeability of the inventive multilayer film adjustable.

It can also be preferred that the water vapor permeability of the first plastic material is greater than the water vapor permeability or the overall water vapor permeability of the inventive multilayer film. This results simply from the fact that the inventive multilayer film is provided with at least two layers (the base layer and the at least one second layer).

Water vapor permeability is measured in accordance with DIN 53122-1, Part 1, gravimetric method (August 2001) at 23° C. and at a relative humidity of 85% in the vaporization space (climate D), whereby the base layer is oriented to the vaporization space and the second layer is oriented to the absorption space.

The base layer preferably has a water vapor permeability in the range of at least 0.5 g/(m²*d) to 100 g/(m²*d), preferably 0.75 g/(m²*d) to 50 g/(m²*d), more preferably 1.0 g/(m²*d) to 40 g/(m²*d), particularly preferably 1.5 g/(m²*d) to 35 g/(m²*d), very particularly preferably 2.0 g/(m²*d) to 30 g/(m²*d) or 2.5 g/(m²*d) to 25 g/(m²*d), or most preferably 3.0 g/(m²*d) to 20 g/(m²*d).

The plastic material of the second layer preferably has a water vapor permeability of at least greater than 0.1 g/(m²*d), preferably greater than 0.3 g/(m²*d), more preferably greater than 1.0 g/(m²*d), particularly preferably greater than 5 g/(m²*d), very particularly preferably greater than 10 g/(m²*d) or greater than 20 g/(m²*d), or most preferably greater than 30 g/(m²*d). Most particularly preferable is a water vapor permeability of no more than 100 g/(m²*d), preferably of no more than 50 g/(m²*d), and particularly preferably of 40 g/(m²*d).

The inventive multilayer film preferably has a water vapor permeability in the range of at least 0.5 g/(m²*d) to 90 g/(m²*d), preferably 1.0 g/(m²*d) to 70 g/(m²*d), more preferably 1.5 g/(m²*d) to 50 g/(m²*d), particularly preferably 2.0 g/(m²*d) to 30 g/(m²*d), very particularly preferably 2.5 g/(m²*d) to 25 g/(m²*d) or 3.0 g/(m²*d) to 20 g/(m²*d), or most preferably 5.0 g/(m²*d) to 15 g/(m²*d).

In one preferred embodiment, the inventive multilayer film is adaptive to moisture only to a limited extent. If water vapor permeability WDD2 is measured using DIN 53122-1, Part 1, at 23° C. and a relative humidity of 50% rel. hum. in the evaporation space (for instance a well ventilated environmental testing space) and compared to water vapor permeability WDD1 in accordance with DIN 53122-1, Part 1, gravimetric method (August 2001) at 23° C. and a relative humidity of 85% in the evaporation space (climate D), the ratio WDD1/WDD2 is less than 15, preferably less than 10, more preferably less than 8, particularly preferably less than 6, very particularly preferably less than 4, and most preferably less than 2.

In another preferred embodiment, the inventive multilayer film is adaptive to moisture only to a limited extent with respect to the properties at high humidity. If water vapor permeability WDD3 is measured using DIN 12572, test conditions C (information on behavior of materials at high humidity) and compared to water vapor permeability WDD1 in accordance with DIN 53122-1, Part 1, gravimetric method (August 2001) at 23° C. and a relative humidity of 85% in the evaporation space (climate D), the ratio WDD3/WDD1 is less than 12, preferably less than 6, more preferably less than 4, particularly preferably less than 3, very particularly preferably less than 2, and most preferably less than 1.5.

In accordance with the invention, the base layer of the inventive multilayer film is preferably extensible in a first direction, preferably a production direction, and the holes of the second layer are arranged such that the second layer is also extensible in the first direction, whereby the extensibility starting from the unextended condition is at least 20%, preferably at least 35%, particularly preferably at least 100%, and most preferably at least 200%. The extensibility can preferably occur using appropriate selection of the first and/or second plastic material, whereby the extensibility of this layer is especially to be assured by the size and position of the holes of the second layer. In general, the “production direction” is the direction in which a web of the multilayer film is produced during the production process. The web can preferably be wound onto a corresponding roller. Because of the extensibility in at least a first direction, the inventive multilayer film preferably offers particularly secure and leak-free layability, in particular in the area of joints. Warping also occurs less frequently because of this, or even not at all, and can thus be compensated.

Particularly preferably, the base layer is also extensible in a second direction perpendicular to the first direction and the holes of the second layer are arranged such that the second layer is also extensible in the second direction, whereby the extensibility starting from the unextended condition is at least 20%, preferably at least 35%, particularly preferably at least 100%, and most preferably at least 200%. In this case as well the extensibility can be additionally enhanced or obtained using appropriate material selection, as described in the foregoing. The extensibility in the second direction should in general mean that the multilayer film is inventively particularly preferably extensible perpendicular to the first direction as well, whereby naturally extensibility at oblique angles to the first direction and the second direction will occur in practice.

In one preferred embodiment, the multilayer film is also still water-tight with respect to low surface tension water even during and after extension in a direction that is longitudinal and/or transverse to the production direction. The film is preferably also still water-tight with respect to low surface tension water even during an extension of at least 20% in at least one direction, and is particularly preferably still water-tight with respect to low surface tension water even during an extension of at least 50% in at least one direction.

In accordance with one preferred embodiment, the first plastic material is a water vapor permeable material or a polyolefin material made of polyethylene, e.g. a polyethylene which is or has properties of LDPE (low density polyethylene), MDPE (medium density polyethylene), HDPE (high density polyethylene), or LLDPE (linear low density polyethylene), polypropylene, or a copolymer comprising ethylene or propylene or butylene or butadiene or isoprene or a combination thereof, and the plastic material contains a material for enhancing the water vapor permeability, preferably made of polyvinyl alcohol, polyvinyl pyrrolidone, acrylic acid homopolymers, acrylic acid copolymers, cellulose fibers, polyurethanes, polyesters, in particular polyurethanes and polyesters based on polyether polyols, (for instance PTMEG and PPO), polyester polyols, or made of minerals, particularly preferably calcium carbonate or styrene or a mixture of calcium carbonate and styrene. The water vapor permeability of the base layer is thus adjusted using the at least one material for enhancing the water vapor permeability.

In accordance with another preferred embodiment, the second plastic material is a polyolefin material, e.g. made of polyethylene, e.g. a polyethylene which is or has properties of LDPE (low density polyethylene), MDPE (medium density polyethylene), HDPE (high density polyethylene), or LLDPE (linear low density polyethylene), polypropylene, or a copolymer comprising ethylene or propylene or a combination thereof.

It is inventively preferred that the base layer and the at least one additional second layer are coupled to one another with an interposing coupling layer, wherein the coupling layer comprises a contact adhesive, preferably adhesive or a hot melt adhesive, reactive adhesive (for instance 2-component polyurethane adhesive), or a polyolefin material, preferably comprising polyethylene which is or has properties of LDPE (low density polyethylene), MDPE (medium density polyethylene), HDPE (high density polyethylene), or LLDPE (linear low density polyethylene), polypropylene, or a copolymer comprising ethylene or propylene or a combination thereof. The base layer and the second layer can preferably also be coupled using heat-melting, for instance by flaming, thermolamination, or thermocalendering.

In one particularly preferred variant, the coupling layer is a water vapor permeable material, in particular a water vapor permeable plastic material, preferably a polyolefin material made of polyethylene, e.g. a polyethylene which is or has properties of LDPE (Low Density Polyethylene), MDPE (Medium Density Polyethylene), HDPE (High Density Polyethylene) or LLDPE (Linear Low Density Polyethylene), polypropylene, or comprising a copolymer comprising ethylene or propylene or butylene or butadiene or isoprene or a combination thereof, and the plastic material of the coupling layer contains at least one material for enhancing water vapor permeability, preferably made of polyvinyl alcohol, polyvinyl pyrrolidone, acrylic acid homopolymers, acrylic acid copolymers, cellulose fibers, polyurethanes, polyesters, in particular polyurethanes and polyesters based on polyether polyols (for instance PTMEG and PPO), polyester polyols, or made of minerals, particularly preferably calcium carbonate, or polystyrene, or a mixture of calcium carbonate and polystyrene.

This inventively preferred design offers a variable option for adjusting the appropriate product parameters with relatively simple and cost-effective producibility of the inventive multilayer film.

In accordance with one preferred embodiment of the inventive multilayer film, the coupling layer has a thickness between 0.0001 mm and 0.1 mm, preferably between 0.0005 mm and 0.05 mm, and particularly preferably between 0.001 mm and 0.03 mm, and the coupling layer can also preferably be provided with holes that are arranged flush with the holes of the second layer or the coupling layer preferably extends across the entire surface between the base layer and the second layer. However, the coupling layer, or the material of the coupling layer, can also be distributed, in particular applied, in points or strips across the entire surface. Thus, with simple producibility, further enhanced very good coupling, and thus mechanical stability of the individual layers of the inventive multilayer film, can be attained.

Particularly preferred is an embodiment of the inventive multilayer film in which the inventive multilayer film has a contact adhesive coating, preferably made of adhesive or a hot melt adhesive, on at least one of the surfaces, preferably on the base layer and/or on the at least one second layer. When the width of such a multilayer film is appropriately selected, this embodiment makes it possible to assure either direct gluing, and thus simpler handling, of such a multilayer film, or to employ a multilayer film preferably thus designed inventively as an adhesive tape for sealing joints, whereby the inventive adjustability of the water vapor permeability avoids formation of condensation in the area of the edges to be glued, which is not possible with conventional adhesive tapes from the prior art, especially film adhesive tapes. The preferred given flexibility and/or extensibility of the inventive multilayer film is particularly advantageous since warping is avoided and gaps in the joint area cannot occur or can be compensated.

In order to assure very good mechanical stability of the inventive multilayer film, in accordance with one preferred embodiment of the invention the base layer has a thickness of at least 0.005 mm, preferably of at least 0.01 mm, more preferably of at least 0.03 mm, particularly preferably of at least 0.06 mm, even more preferably of at least 0.09 mm, and most preferably of at least 0.15 mm.

For assuring mechanical stability, in accordance with one preferred embodiment the second layer has a thickness of at least 0.002 mm, preferably of at least 0.005 mm, particularly preferably of at least 0.01 mm or 0.02 mm, even more preferably of at least 0.04 mm, and most preferably of at least 0.08 mm.

In one preferred embodiment, the multilayer film has a thickness of at least 0.03 mm, preferably at least 0.05 mm, particularly preferably at least 0.075 mm or 0.1 mm, even more preferably at least 0.15 mm, and most preferably at least 0.2 mm.

Particularly preferred is one embodiment of the inventive multilayer film that has a water vapor permeability-controlling third layer that is provided with holes, the arrangement of which removes a defined surface area so that the water vapor permeability of the multilayer film is adjusted. With regard to this third layer, all of the statements made in the foregoing regarding the arrangement, design, and coupling of the second layer apply, and it should also be mentioned that the holes of the second layer can preferably be in registry with the holes of the third layer, and that the third layer can be arranged on the side of the base layer that opposes the second layer. However, there can also be the option of using a suitable intermediate layer to attach in a coupled manner the third layer to the second layer. The third layer can also correspondingly be provided with a contact adhesive coating described in the foregoing.

In order to be able to adjust the water vapor permeability of the inventive multilayer film across a particularly large area, the defined removed surface area of the second layer (and/or also of the third layer, if any) is no more than 80%, preferably no more than 60%, particularly preferably no more than 40%, or most preferably no more than 30%. Preferably the minimum value of the defined removed surface area of the second layer (and/or also of the third layer, if any) is 1%.

The multilayer film is suitable for use as a film for sealing in home or other building construction without additional reinforcements. However, in one preferred embodiment for sealing with particularly high mechanical stability, the inventive multilayer film can be further reinforced. Suitable reinforcements can be: one reinforcing layer or a plurality of reinforcing layers made of laminated non-woven fabrics, woven fabrics, or interlaid scrims. The reinforcing layer or layers can be worked in as intermediate layer or layers and/or can be laminated on at least one exterior side.

In accordance with one preferred embodiment, the inventive multilayer film can have a width in a range from 400 mm to 5000 mm, preferably in a range of 500 mm to 4200 mm, even more preferably in a range of 600 mm to 3000 mm, particularly preferably in a range of 800 mm to 2500 mm, and most preferably in a range of 900 mm to 2000 mm. Thus application preferably as film for sealing in the roof area during home construction is covered.

The inventive multilayer film can preferably also have a width in a range of 30 mm to 400 mm, preferably in a range of 40 mm to 350 mm, and particularly preferably in a range of 60 mm to 250 mm, i.e. the inventive multilayer film can also essentially be used as a tape-like film, in particular as an adhesive assembly tape for sealing and/or gluing joints when sealing in the roof area during home construction.

The multilayer film can preferably be made flame-retardant. For this purpose, the plastic material of the base layer and/or of the second layer and/or of the coupling layer can be provided with flame-retardant additives such as for instance antimony compounds or phosphorus compounds.

In accordance with one preferred embodiment, the inventive multilayer film can be made light and UV stable. For this purpose, the plastic material of the base layer and/or of the second layer and/or of the coupling layer can be provided with light and/or UV light stabilizers for instance based on inorganic compounds such as zinc oxide or carbon black or on organic compounds such as for instance from the HALS (hindered amine light stabilizers) group.

In accordance with one preferred embodiment, the inventive multilayer film can be rendered antistatic. For this, the plastic material of the base layer and/or of the second layer and/or of the coupling layer can be provided with antistatic agents, for instance based on alkyl amines or amides.

The multi-layer film described in the foregoing can be inventively used as adhesive tape, in particular for sealing in the roof area during home construction.

The multilayer film described in the foregoing can inventively be used as a vapor barrier, in particular for sealing in the roof area during home construction.

The multilayer film described in the foregoing can inventively be used as on-roof film and/or facade film, in particular for sealing in the roof area and/or wall area during home construction.

In accordance with the invention, a system can also be provided that comprises the multilayer film described in the foregoing and an adhesive tape that comprises the multilayer film described in the foregoing. Such a system offers the special advantage that the multilayer film and the associated adhesive tape made of the corresponding multilayer film have the same or at least largely the same product properties, in particular with respect to mechanical stability, extensibility, and water vapor permeability, so that each time it is used it is possible to obtain optimum sealing with such a system.

The inventive method for producing a multilayer film that is water-tight and water vapor permeable, in particular for sealing in the roof area during home construction, in particular a multilayer film with the properties described in the foregoing, whereby the water vapor permeability of the multilayer film is adjusted, is characterized by the following steps:
providing a base layer that is water vapor permeable and water-tight for low surface tension water and that is made of a first plastic material;
providing at least one water vapor permeability-controlling second layer made of a second plastic material;
removing a defined surface area from the second plastic material of the second layer by providing the second layer with macroscopic holes; and
coupling the second layer to the base layer, whereby after the coupling of the water vapor permeable base layer to the second layer with a defined removed surface area the water vapor permeability of the multilayer film is adjusted in a targeted manner.

Preferably a water vapor permeability-controlling third layer is coupled to the base layer, whereby the third layer is provided in advance with holes, the arrangement of which removes a defined surface area of this third layer.

The coupling step preferably occurs using heat-melting, particularly preferably using flaming, or preferably using thermolamination or preferably using thermocalendering. The inventive multilayer film is described in more detail in the following using an exemplary embodiment and the attached drawings.

### BRIEF DESCRIPTION OF THE DRAWINGS

FIG. 1 is a sectional view of a multilayer film in accordance with one preferred embodiment of the present invention.

FIG. 2a is a top view of a preferred embodiment of the inventive multilayer film in its unextended condition; and

FIG. 2b is a top view of an embodiment of the inventive multilayer film in FIG. 2a in an extended condition.

### DETAILED DESCRIPTION OF THE INVENTION

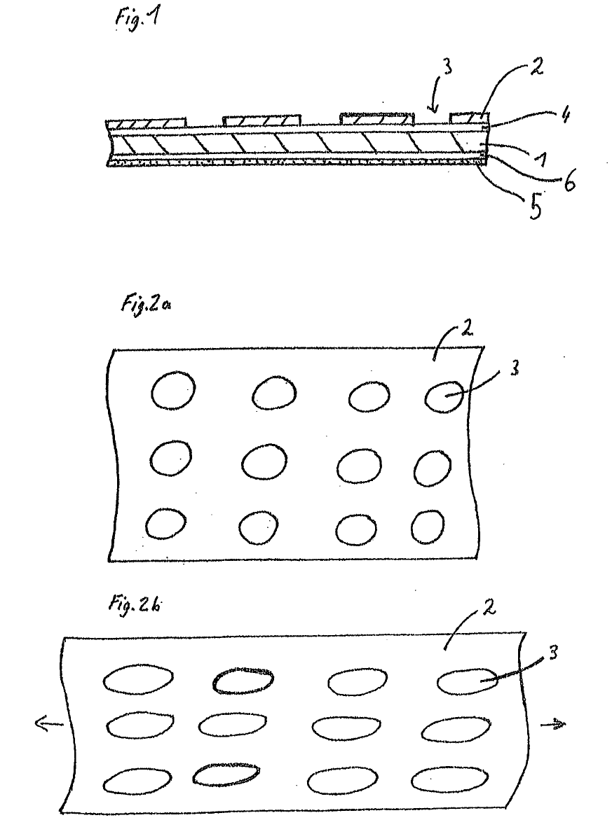

FIG. 1 is a schematic sectional view of a preferred embodiment of the inventive multilayer film. The multilayer film has a water vapor permeable base layer 1 made of a first plastic material and a water vapor permeability-controlling second layer 2 made of a second plastic material, and the water vapor permeability-controlling second layer 2 is provided with macroscopic holes 3, the arrangement of which removes a defined surface area from the second plastic material of the second layer so that the water vapor permeability of the multilayer film is adjusted. In accordance with the embodiment illustrated in FIG. 1, the inventive multilayer film has a coupling layer 4 between the base layer 1 and the second layer 2, through which coupling layer the base layer 1 and the second layer 2 are coupled to one another. The coupling layer can comprise a contact adhesive, preferably adhesive or a hot melt adhesive, a reactive adhesive (for instance 2-component polyurethane adhesive), or a polyolefin material, preferably polyethylene which is or has properties of LDPE (low density polyethylene), MDPE (medium density polyethylene), HDPE (high density polyethylene), or LLDPE (linear low density polyethylene), polypropylene, or a copolymer comprising ethylene or propylene or a combination thereof, and/or comprising a water vapor permeable material or a polyolefin material made of polyethylene, e.g. a polyethylene which is or has properties of LDPE (Low Density Polyethylene), MDPE (Medium Density Polyethylene), HDPE (High Density Polyethylene) or LLDPE (Linear Low Density Polyethylene), polypropylene, or a copolymer comprising ethylene or propylene or a combination thereof, and the plastic material contains at least one material for enhancing the water vapor permeability, preferably made of polyvinyl alcohol, polyvinyl pyrrolidone, acrylic acid hompolymers, acrylic acid copolymers, cellulose fibers, polyurethanes, polyesters, in particular polyurethanes and polyesters based on polyether polyols (for instance PTMEG and PPO), or made of minerals, particularly preferred calcium carbonate, polystyrene, or a mixture of calcium carbonate and polystyrene. In accordance with the preferred embodiment illustrated in FIG. 1, provided on the base layer 1 is a contact adhesive coating 5, particularly preferably made of adhesive or a hot melt adhesive, with which the inventive multilayer film can be glued. In one preferred embodiment, the inventive multilayer film can additionally be reinforced for seals with particularly high mechanical load. Suitable reinforcements can be: one reinforcing layer or a plurality of reinforcing layers (not shown) made of laminated non-woven fabrics, woven fabrics, or interlaid scrims. The reinforcing layer or layers can either be worked in as intermediate layer or layers or can be laminated on at least one exterior side. The embodiment in FIG. 1 illustrates an embodiment with a reinforcing layer 6 on the base layer 1.

FIG. 2a is a top view of the inventive multilayer film, wherein the second layer 2 provided with the holes 3 is shown in the unextended condition. In accordance with FIG. 2a, the holes 3 are arranged distributed as circular holes in uniform rows and columns across the second layer of the illustrated multilayer film. The shape and arrangement of the holes 3 can be determined based on the use, e.g. can even be rhomboidal.

FIG. 2 is a top view of the embodiment of the multilayer film in accordance with FIG. 2a, however in the extended condition. The extension is indicated by the two arrows. Through the extension, the holes 3, which in accordance with the embodiment are actually round (in the unextended condition) are now elliptically distorted in the extended condition. The inventive preferred extensibility of the inventive multilayer film is provided by this distortability in accordance with the illustrated embodiment.

The inventive multilayer film is relatively simple and inexpensive to produce and offers adjustable water vapor permeability, water-tightness even for low surface tension water, and very good mechanical stability.

1.-36. (canceled)

37. Multilayer film that is water-tight and water vapor permeable, comprising a water vapor permeable base layer comprised of a first plastic material and a water vapor permeability-controlling second layer coupled to the base layer and comprised of a second plastic material, the multilayer film being extensible and tear-resistant, the base layer being water-tight with respect to the low surface tension water, and the second layer being provided with macroscopic holes which remove a predetermined surface area from the second layer thereby to adjust water vapor permeability of the multilayer film.

38. Multilayer film according to claim 37, wherein the tear resistance thereof in accordance with DIN 53504 is greater than 3 N/mm².

39. Multilayer film according to claim 37, wherein the tear resistance thereof in accordance with DIN 53504 is greater than 5 N/mm².

40. Multilayer film according to claim 37, wherein the tear resistance thereof in accordance with DIN 53504 is greater than 7 N/mm².

41. Multilayer film according to claim 37, wherein the tear resistance thereof in accordance with DIN 53504 is greater than 9 N/mm².

42. Multilayer film according to claim 37, wherein the tear resistance thereof in accordance with DIN 53504 is greater than 11 N/mm².

43. Multilayer film according to claim 37, wherein the tear resistance thereof in accordance with DIN 53504 is greater than 13 N/mm².

44. Multilayer film according to claim 37, wherein the tear resistance thereof in accordance with DIN 53504 is greater than 15 N/mm².

45. Multilayer film according to claim 37, wherein the macroscopic holes comprise holes of at least one of the following shapes: round, oval, square, rectangular, rhomboidal.

46. Multilayer film according to claim 37, wherein the macroscopic holes comprise holes of diameter 0.1 mm to 100 mm.

47. Multilayer film according to claim 37, wherein the macroscopic holes comprise holes of diameter 0.2 mm to 50 mm.

48. Multilayer film according to claim 37, wherein the macroscopic holes comprise holes of diameter 0.4 mm to 20 mm.

49. Multilayer film according to claim 37, wherein the macroscopic holes comprise holes of diameter 0.5 mm to 8 mm.

50. Multilayer film according to claim 37, wherein the macroscopic holes comprise holes of diameter 0.6 mm to 6 mm.

51. Multilayer film according to claim 37, wherein the first plastic material is of greater water vapor permeability than the second plastic material.

52. Multilayer film according to claim 37, wherein water vapor permeability of the base layer is 0.5 g/(m²*d) to 100 g/(m²*d).

53. Multilayer film according to claim 37, wherein water vapor permeability of the base layer is 0.75 g/(m²*d) to 50 g/(m²*d).

54. Multilayer film according to claim 37, wherein water vapor permeability of the base layer is 1 g/(m²*d) to 40 g/(m²*d).

55. Multilayer film according to claim 37, wherein water vapor permeability of the base layer is 1.5 g/(m²*d) to 35 g/(m²*d).

56. Multilayer film according to claim 37, wherein water vapor permeability of the base layer is 2 g/(m²*d) to 30 g/(m²*d).

57. Multilayer film according to claim 37, wherein water vapor permeability of the base layer is 2.5 g/(m²*d) to 25 g/(m²*d).

58. Multilayer film according to claim 37, wherein water vapor permeability of the base layer is 3 g/(m²*d) to 20 g/(m²*d).

59. Multilayer film according to claim 37, wherein water vapor permeability of said second plastic material is greater than 0.1 g/(m²*d).

60. Multilayer film according to claim 37, wherein water vapor permeability of said second plastic material is greater than 0.3 g/(m²*d).

61. Multilayer film according to claim 37, wherein water vapor permeability of said second plastic material is greater than 1 g/(m²*d).

62. Multilayer film according to claim 37, wherein water vapor permeability of said second plastic material is greater than 5 g/(m²*d).

63. Multilayer film according to claim 37, wherein water vapor permeability of said second plastic material is greater than 10 g/(m²*d).

64. Multilayer film according to claim 37, wherein water vapor permeability of said second plastic material is greater than 20 g/(m²*d).

65. Multilayer film according to claim 37, wherein water vapor permeability of said second plastic material is greater than 30 g/(m²*d).

66. Multilayer film according to claim 65, wherein the water vapor permeability of said second plastic material is no greater than 100 g/(m²*d).

67. Multilayer film according to claim 65, wherein the water vapor permeability of said second plastic material is no greater than 50 g/(m²*d).

68. Multilayer film according to claim 65, wherein the water vapor permeability of said second plastic material is no greater than 40 g/(m²*d).

69. Multilayer film according to claim 37 of water vapor permeability of 0.5 g/(m²*d) to 90 g/(m²*d).

70. Multilayer film according to claim 37 of water vapor permeability of 1 g/(m²*d) to 70 g/(m²*d).

71. Multilayer film according to claim 37 of water vapor permeability of 1.5 g/(m²*d) to 50 g/(m²*d).

72. Multilayer film according to claim 37 of water vapor permeability of 2 g/(m²*d) to 30 g/(m²*d).

73. Multilayer film according to claim 37 of water vapor permeability of 2.5 g/(m²*d) to 25 g/(m²*d).

74. Multilayer film according to claim 37 of water vapor permeability of 3 g/(m²*d) to 20 g/(m²*d).

75. Multilayer film according to claim 37 of water vapor permeability of 5 g/(m²*d) to 15 g/(m²*d).

76. Multilayer film according to claim 37 of a ratio WDD1/WDD2 of less than 15, wherein WDD2 is water vapor permeability measured using DIN 53122-1, Part 1, at 23° C. and relative humidity of 50% in the evaporation space and WDD1 is water vapor permeability in accordance with DIN 53122-1, Part 1, gravimetric method (August 2001) at 23° C. and relative humidity 85% in the evaporation space (climate D).

77. Multilayer film according to claim 37 of a ratio WDD1/WDD2 of less than 10, wherein WDD2 is water vapor permeability measured using DIN 53122-1, Part 1, at 23° C. and relative humidity of 50% in the evaporation space and WDD1 is water vapor permeability in accordance with DIN 53122-1, Part 1, gravimetric method (August 2001) at 23° C. and relative humidity 85% in the evaporation space (climate D).

78. Multilayer film according to claim 37 of a ratio WDD1/WDD2 of less than 8, wherein WEE2 is water vapor permeability measured using DIN 53122-1, Part 1, at 23° C. and relative humidity of 50% in the evaporation space and WDD1 is water vapor permeability in accordance with DIN 53122-1, Part 1, gravimetric method (August 2001) at 23° C. and relative humidity 85% in the evaporation space (climate D).

79. Multilayer film according to claim 37 of a ratio WDD1/WDD2 of less than 6, wherein WDD2 is water vapor permeability measured using DIN 53122-1, Part 1, at 23° C. and relative humidity of 50% in the evaporation space and WDD1 is water vapor permeability in accordance with DIN 53122-1, Part 1, gravimetric method (August 2001) at 23° C. and relative humidity 85% in the evaporation space (climate D).

80. Multilayer film according to claim 37 of a ratio WDD1/WDD2 of less than 4, wherein WDD2 is water vapor permeability measured using DIN 53122-1, Part 1, at 23° C. and relative humidity of 50% in the evaporation space and WDD1 is water vapor permeability in accordance with DIN 53122-1, Part 1, gravimetric method (August 2001) at 23° C. and relative humidity 85% in the evaporation space (climate D).

81. Multilayer film according to claim 37 of a ratio WDD1/WDD2 of less than 2, wherein WDD2 is water vapor permeability measured using DIN 53122-1, Part 1, at 23° C. and relative humidity of 50% in the evaporation space and WDD1 is water vapor permeability in accordance with DIN 53122-1, Part 1, gravimetric method (August 2001) at 23° C. and relative humidity 85% in the evaporation space (climate D).

82. Multilayer film according to claim 37, wherein the base layer is extensible in a first direction which is the direction in which the film was produced and the macroscopic holes are so arranged as to prevent extensibility of the second layer in the first direction.

83. Multilayer film according to claim 82, wherein the extensibility of the base and second layers in the first direction, starting from unextended condition of the layers, is at least 20%.

84. Multilayer film according to claim 82, wherein the extensibility of the base and second layers in the first direction, starting from unextended condition of the layers, is at least 35%.

85. Multilayer film according to claim 82, wherein the extensibility of the base and second layers in the first direction, starting from unextended condition of the layers, is at least 100%.

86. Multilayer film according to claim 82, wherein the extensibility of the base and second layers in the first direction, starting from unextended condition of the layers, is at least 200%.

87. Multilayer film according to claims 82, wherein the base layer is extensible also in a second direction which is perpendicular to the first direction and the macroscopic holes are so arranged as to promote extensibility of the second layer also in the second direction

88. Multilayer film according to claim 87, wherein the extensibility of the base and second layers in the second direction, starting from unextended condition of the layers, is at least 20%.

89. Multilayer film according to claim 87, wherein the extensibility of the base and second layers in the second direction, starting from unextended condition of the layers, is at least 35%.

90. Multilayer film according to claim 87, wherein the extensibility of the base and second layers in the second direction, starting from unextended condition of the layers, is at least 100%.

91. Multilayer film according to claim 87, wherein the extensibility of the base and second layers in the second direction, starting from unextended condition of the layers, is at least 200%.

92. Multilayer film according to claim 37, wherein when the base and second layers have each been extended at least 20% in a first direction which is the direction in which the respective layer has been produced and/or a second direction which is perpendicular to the first direction, the multilayer film is still water-tight with respect to low surface tension water.

93. Multilayer film according to claim 92, wherein the multilayer film is still water-tight with respect to low surface tension water when the extension of the base and second layers in the first direction and/or the second direction is at least 50%.

94. Multilayer film according to claim 37, wherein the first plastic material is water vapor permeable.

95. Multilayer film according to claim 37, wherein the first plastic material comprises a polyolefin.

96. Multilayer film according to claim 95, wherein the polyolefin comprises polyethylene and/or polypropylene and/or a copolymer comprising ethylene and/or propylene and/or butylene and/or butadiene and/or isoprene and the first plastic material further comprises at least one material for enhancing water vapor permeability.

97. Multilayer film according to claim 96, wherein the polyethylene comprises low density polyethylene and/or medium density polyethylene and/or high density polyethylene and/or linear low density polyethylene.

98. Multilayer film according to claim 96, wherein the material for enhancing water vapor permeability comprises at least one member selected from the group consisting of polyvinyl alcohol, polyvinyl pyrolidone, acrylic acid hompolymers and copolymers, cellulose fibers, polyurethanes, polyesters, polyester polyols, minerals, compositions comprised of minerals, and polystyrene.

99. Multilayer film according to claim 98, wherein the polyurethanes and polyesters are based on polyether polyols.

100. Multilayer film according to claim 99, in which the polyether polyols on which the polyurethanes and polyesters are based are PTMEG and/or PPO.

101. Multilayer film according to claim 98, wherein the minerals comprise calcium carbonate and the compositions comprised of minerals comprise mixtures of calcium carbonate and polystyrene.

102. Multilayer film according to claim 37, wherein the second plastic material comprises a polyolefin.

103. Multilayer film according to claim 102, wherein the polyolefin comprises polyethylene and/or polypropylene and/or copolymers comprising ethylene and/or propylene.

104. Multilayer film according to claim 102, wherein the polyethylene comprises low density polyethylene and/or medium density polyethylene and/or high density polyethylene and/or linear low density polyethylene and/or polypropylene and/or copolymers comprising ethylene and/or propylene.

105. Multilayer film according to claim 37, wherein the coupling of the second layer to the base layer comprises a bond formed by heat-melting, thermolamination or thermocalendering.

106. Multilayer film according to claim 105, wherein the bond formed by heat-melting is a bond formed by heat-melting by flaming.

107. Multilayer film according to claim 37, further comprising a coupling layer interposed between the base layer and the second layer, the coupling layer comprising the coupling of the second layer to the base layer.

108. Multilayer film according to claim 107, wherein the coupling layer comprises an adhesive or a polyolefin.

109. Multilayer film according to claim 108, wherein the adhesive comprises a contact adhesive or a hot melt adhesive or a reactive adhesive and the polyolefin comprises low density polyethylene and/or medium density polyethylene and/or high density polyethylene and/or linear low density polyethylene and/or polypropylene and/or copolymers comprising ethylene and/or propylene.

110. Multilayer film according to claim 109, wherein the reactive adhesive comprises a two-component polyurethane adhesive.

111. Multilayer film according to claim 107, wherein the coupling layer comprises a water vapor permeable material or a plastic material comprising polyethylene and/or polypropylene and/or copolymers comprising ethylene and/or propylene and/or butylene and/or butadiene and/or isoprene and the plastic material of the coupling layer further comprises at least one material for enhancing water vapor permeability.

112. Multilayer film according to claim 111, wherein the polyethylene comprises low density polyethylene and/or medium density polyethylene and/or high density polyethylene and/or linear low density polyethylene.

113. Multilayer film according to claim 111, wherein the material for enhancing water vapor permeability is at least one member selected from the group consisting of polyvinyl alcohol, polyvinyl pyrrolidone, acrylic acid hompolymers and copolymers, cellulose fibers, polyurethanes , polyesters, polyester polyols, minerals, compositions comprised of minerals and polystyrene.

114. Multilayer film according to claim 113, wherein the polyurethanes and polyesters are based on polyether polyols.

115. Multilayer film according to claim 114, in which the polyether polyols on which the polyurethanes and polyesters are based are PTMEG and/or PPO.

116. Multilayer film according to claim 113, wherein the minerals comprise calcium carbonate and the compositions comprised of minerals comprise mixtures of calcium carbonate and polystyrene.

117. Multilayer film according to claim 107, wherein the coupling layer is of thickness 0.0001 mm to 0.1 mm.

118. Multilayer film according to claim 107, wherein the coupling layer is of thickness 0.0005 mm to 0.05 mm.

119. Multilayer film according to claim 107, wherein the coupling layer is of thickness 0.001 mm to 0.03 mm.

120. Multilayer film according to claim 117, wherein the coupling layer is provided with holes which are in registry with the macroscopic holes.

121. Multilayer film according to claim 117, wherein the coupling layer is coextensive with the base layer and the second layer.

122. Multilayer film according to claim 37, further comprising at least one respective adhesive coating comprising at least one respective face of the multilayer film.

123. Multilayer film according to claim 37, wherein the base layer is of thickness at least 0.005 mm.

124. Multilayer film according to claim 37, wherein the base layer is of thickness at least 0.01 mm.

125. Multilayer film according to claim 37, wherein the base layer is of thickness at least 0.03 mm.

126. Multilayer film according to claim 37, wherein the base layer is of thickness at least 0.06 mm.

127. Multilayer film according to claim 37, wherein the base layer is of thickness at least 0.09 mm.

128. Multilayer film according to claim 37, wherein the base layer is of thickness at least 0.15 mm.

129. Multilayer film according to claim 37, wherein the second layer is of thickness at least 0.002 mm.

130. Multilayer film according to claim 37, wherein the second layer is of thickness at least 0.005 mm.

131. Multilayer film according to claim 37, wherein the second layer is of thickness at least 0.01 mm.

132. Multilayer film according to claim 37, wherein the second layer is of thickness at least 0.02 mm.

133. Multilayer film according to claim 37, wherein the second layer is of thickness at least 0.04 mm.

134. Multilayer film according to claim 37, wherein the second layer is of thickness at least 0.08 mm.

135. Multilayer film according to claim 37, wherein the multilayer film is of thickness at least 0.03 mm.

136. Multilayer film according to claim 37, wherein the multilayer film is of thickness at least 0.05 mm.

137. Multilayer film according to claim 37, wherein the multilayer film is of thickness at least 0.075 mm.

138. Multilayer film according to claim 37, wherein the multilayer film is of thickness at least 0.1 mm.

139. Multilayer film according to claim 37, wherein the multilayer film is of thickness at least 0.15 mm.

140. Multilayer film according to claim 37, wherein the multilayer film is of thickness at least 0.2 mm.

141. Multilayer film according to claim 37, comprising a third layer, the third layer being provided with holes which remove a predetermined surface area from the third layer thereby to adjust water vapor permeability of the multilayer film.

142. Multilayer film according to claim 141, wherein the predetermined surface area removed from the second layer and/or the third layer is no more than 80% of the total surface area of the respective layer.

143. Multilayer film according to claim 141, wherein the predetermined surface area removed from the second layer and/or the third layer is no more than 60% of the total surface area of the respective layer.

144. Multilayer film according to claim 141, wherein the predetermined surface area removed from the second layer and/or the third layer is no more than 40% of the total surface area of the respective layer.

145. Multilayer film according to claim 141, wherein the predetermined surface area removed from the second layer and/or the third layer is no more than 30% of the total surface area of the respective layer.

146. Multilayer film according to claim 141, wherein the predetermined area removed from the second layer and/or the third layer is at least 1% of the total surface area of the respective layer.

147. Multilayer film according to claim 37, further comprising at least one reinforcing layer comprising an intermediate and/or exterior layer of the multilayer film.

148. Multilayer film according to claim 147, wherein the reinforcing layer comprises a non-woven fabric and/or a woven fabric and/or a scrim.

149. Multilayer film according to claim 37, wherein the multilayer film is of width 400 mm to 5000 mm.

150. Multilayer film according to claim 37, wherein the multilayer film is of width 500 mm to 4200 mm.

151. Multilayer film according to claim 37, wherein the multilayer film is of width 600 mm to 3000 mm.

152. Multilayer film according to claim 37, wherein the multilayer film is of width 800 mm to 2500 mm.

153. Multilayer film according to claim 37, wherein the multilayer film is of width 900 mm to 2000 mm.

154. Multilayer film according to claim 37, wherein the multilayer film is of width 30 mm to 400 mm.

155. Multilayer film according to claim 37, wherein the multilayer film is of width 40 mm to 350 mm.

156. Multilayer film according to claim 37, wherein the multilayer film is of width 60 mm to 250 mm.

157. Multilayer film according to claim 107, wherein the base layer and/or the second layer and/or the coupling layer contains at least one flame-retardant additive.

158. Multilayer film according to claim 157, wherein the flame-retardant additives comprise antimony compounds and/or phosphorus compounds.

159. Multilayer film according to claim 107, wherein the base layer and/or the second layer and/or the coupling layer contains at least one light and/or UV light stabilizer.

160. Multilayer film according to claim 159, wherein the light and/or UV light stabilizers comprise organic and/or inorganic compounds.

161. Multilayer film according to claim 160, wherein the compounds comprise zinc oxide, carbon black and hindered amine light stabilizers.

162. Method of sealing a roof area during construction of the roof, comprising applying the multilayer film of claim 37 in said area.

163. Method of providing a vapor barrier in a roof area during construction of the roof, comprising applying the multilayer film of claim 37 to said area thereby to seal said area.

164. Method of sealing a roof wall or facade of a house or building as a step in construction of the house or building, comprising applying the multilayer film of claim 37 to said roof, wall or facade.

165. A kit or system comprising a multilayer film according to claim 37 and an adhesive tape.

166. Method of providing a multilayer film of claim 37, comprising:
(a) providing the base layer;
(b) providing the second layer;
(c) forming the macroscopic holes in the second layer; and
(d) coupling the second layer to the base layer.

167. Method according to claim 166, wherein the coupling comprises heat-melting or thermolamination or thermocalendering.

168. Method according to claim 167, wherein the heat-melting comprises flaming.

169. Method of producing a multilayer film of claim 141, comprising:
(a) providing the base layer;
(b) providing the second layer;
(c) forming the macroscopic holes in the second layer;
(d) providing the third layer having holes therein; and
(e) coupling the second and third layers to the base layer.

170. Method according to claim 169, wherein the coupling comprises heat-melting or thermocalendering.

171. Method according to claim 170, wherein the heat-melting comprises flaming.
